(19) United States
(12) Patent Application Publication
(10) Pub. No.: US 2025/0191413 A1
(43) Pub. Date: Jun. 12, 2025

(54) DRIVING INFORMATION DISPLAY APPARATUS AND METHOD FOR PROVIDING INFORMATION RELATED TO ELECTRIC VEHICLE CHARGING STATION

(71) Applicants: HYUNDAI MOTOR COMPANY, Seoul (KR); KIA CORPORATION, Seoul (KR); HYUNDAI AUTOEVER CORP, Seoul (KR)

(72) Inventors: Kim Hanshik, Hwaseong-si (KR); Jin Geumdan, Hwaseong-si (KR); Sung Taehyun, Hwaseong-si (KR); Kim Tae Heon, Hwaseong-si (KR); Park Jaeseok, Hwaseong-si (KR); Lee Sang Jun, Hwaseong-si (KR); WonMi Ahn, Seoul (KR); Jin Young Min, Seoul (KR); HwaHyeon Hong, Seoul (KR); Lam Lee, Seoul (KR)

(73) Assignees: HYUNDAI MOTOR COMPANY, Seoul (KR); KIA CORPORATION, Seoul (KR); HYUNDAI AUTOEVER CORP, Seoul (KR)

(21) Appl. No.: 18/955,717

(22) Filed: Nov. 21, 2024

(30) Foreign Application Priority Data
Dec. 7, 2023 (KR) 10-2023-0176536

(51) Int. Cl. G07C 5/00; B60L 53/66; G01C 21/36; H04N 7/18

(52) U.S. Cl. CPC G07C 5/008; B60L 53/66; G01C 21/3679; H04N 7/181

(57) ABSTRACT

In a driving information display apparatus and method for providing information related to an electric vehicle charging station, the driving information display apparatus includes: a processor configured to perform control to receive driving guidance information and the location information of an electric vehicle and output a guidance screen corresponding to the driving guidance information; and a storage unit configured to store road information and an algorithm run by the processor. The processor is configured to perform control to, when a charging station is included in the destination or passage point of the electric vehicle, check whether the electric vehicle has arrived at the charging station included in the destination or passage point, and determine whether a charging station image output condition is satisfied, and output a charging station image of the arrived charging station when the charging station image output condition is satisfied.

### CROSS-REFERENCE TO RELATED APPLICATION

The present application claims priority to Korean Patent Application No. 10-2023-0176536 filed on Dec. 7, 2023, the entire contents of which are incorporated herein for all purposes by this reference.

### BACKGROUND OF THE PRESENT DISCLOSURE

### Field of the Present Disclosure

The present disclosure relates to a driving information display apparatus and method for providing information related to an electric vehicle charging station, and more particularly to an apparatus which provides detailed information including an image of each charger of a charging station used for the charging of an electric vehicle so that a driver can conveniently use the charging station, and a method of operating the same.

### Description of Related Art

As the number of electric vehicles increases, inconveniences in using charging stations are increasing. In some cases, it is difficult to find the precise location of a charging station, and in many cases, a located charger cannot be used because it is in use or is broken.

Accordingly, a related art discloses technology which checks the state of a charging station via a charging station management server and guides a user through the use of the charging station by considering the state of the charging station.

However, even when such technology is employed, there is a problem in that it is difficult to provide accurate guidance due to difficulties in accurately collecting information related to the states of chargers. Therefore, there is a demand for technology which enables users to conveniently check the newest information related to electric vehicle charging stations.

The information included in this Background of the Present Disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing accurate and detailed information related to an electric vehicle charging station.

An object of the present disclosure is to provide a recent image of an electric vehicle charging station so that a driver can accurately check the state of the charging station.

An object of the present disclosure is to extract a charging station image from an image obtained through a camera of an electric vehicle and provide a charging station image corresponding to the success of charging to a driver so that the driver can check the accurate state of a charging station.

An object of the present disclosure is to extract and provide the newest charging station image by analyzing images received from vehicles which used a vehicle charging station without separately capturing the electric vehicle charging station.

The objects to be solved as an exemplary embodiment of the present disclosure are not limited to the objects described above, and other objects may be clearly understood by those skilled in the art from the following detailed description of the present disclosure.

According to various aspects of the present disclosure, there is provided a driving information display apparatus including: a processor configured to perform control to receive driving guidance information and the location information of an electric vehicle and output a guidance screen corresponding to the driving guidance information; and a storage unit configured to store road information and an algorithm run by the processor; wherein the processor is configured to perform control to, when a charging station is included in a destination or passage point of the electric vehicle: check whether the electric vehicle has arrived at the charging station included in the destination or passage point; and determine whether a charging station image output condition is satisfied, and output a charging station image of the arrived charging station when the charging station image output condition is satisfied.

The charging station image output condition may be satisfied when the number of times the driver of the electric vehicle has visited the charging station in the past is less than a predetermined reference number.

The charging station image output condition may be satisfied when the time spanning from the point in time when the electric vehicle arrives at the charging station to the point in time when a parking completion signal is received exceeds a predetermined reference time.

The processor is configured to perform control to: capture an image with a camera attached to the electric vehicle when the electric vehicle arrives at the charging station and the charging port of the electric vehicle is opened; and transmit the captured image, together with information for identifying the arrived charging station, to a driving information management server.

The processor is configured to perform control to: select one camera from a plurality of cameras attached to the electric vehicle based on information related to the direction in which the charging port of the electric vehicle is placed; and capture the image.

The processor is configured to perform control to transmit charging station information including at least one of the success/failure of charging, charging speed, and charging time, together with the captured image, to the driving information management server.

The processor is configured to perform control to: transmit information for identifying the arrived charging station to the driving information management server; and receive a charging station image of the arrived charging station from the driving information management server, and output the charging station image; and the charging station image may be an image which is selected from images, captured and transmitted by a plurality of electric vehicles, by the driving information management server.

According to various aspects of the present disclosure, there is provided a driving information management server provided with a central processing unit and memory, the driving information management server including: a connection setup unit configured to set up connections to exchange information with the driving information display apparatuses of a plurality of electric vehicles; a charging station information storage unit configured to store information for identifying charging stations and charging station images received from the driving information display apparatuses of the plurality of electric vehicles over the set-up connections; and a charging station information transmission unit configured to select one image from the stored charging station images based on information for the identification of a charging station received from the driving information display apparatus of any one of the plurality of electric vehicles, and transmit the selected charging station image to the driving information display apparatus which transmitted the information for the identification of a charging station.

The charging station information storage unit may receive charging station information including at least one of the success/failure of charging, charging speed, and charging time together with each of the charging station images captured by the plurality of electric vehicles, and may store them in association with the information for the identification of a charging station.

The charging station information transmission unit may select and transmit a charging station image, most recently captured when charging was successful, based on the stored charging station information.

The charging station information storage unit may analyze the received charging station image and store the charging station image only when the image includes a charging station and the image quality of the image is equal to or greater than a reference value.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a block diagram showing the internal configuration of a driving information display device according to various exemplary embodiments of the present disclosure;

FIG. 2 is a block diagram showing the internal configuration of a driving information management server according to various exemplary embodiments of the present disclosure;

FIG. 3 is a diagram showing an example of charging station information output from a driving information display apparatus according to various exemplary embodiments of the present disclosure;

FIG. 4 is a diagram showing an example of displaying charging station information using augmented reality in a driving information display apparatus according to various exemplary embodiments of the present disclosure;

FIG. 5A and FIG. 5B are diagrams showing a method of capturing a charging station image according to the location of a charging port in a driving information display apparatus according to various exemplary embodiments of the present disclosure;

FIG. 6A and FIG. 6B are diagrams showing a method of capturing an image of a charging station when it is difficult to capture an image during the charging of an electric vehicle in a driving information display apparatus according to various exemplary embodiments of the present disclosure;

FIG. 7A and FIG. 7B are diagrams showing a method of capturing an image of a charging station when it is difficult to capture an image during the charging of an electric vehicle in a driving information display apparatus according to various exemplary embodiments of the present disclosure;

FIG. 8 shows flowcharts of the operations of a driving information display apparatus and a driving information management server according to various exemplary embodiments of the present disclosure;

FIG. 9 is a flowchart showing the flow of a driving information display method according to various exemplary embodiments of the present disclosure; and

FIG. 10 is a flowchart showing the flow of a driving information management method according to various exemplary embodiments of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Embodiments of the present disclosure will be described in detail below with reference to the accompanying drawings. In the following description of the present disclosure, when it is determined that a detailed description of any related known configuration or function may obscure the gist of the present disclosure, the detailed description will be omitted. Furthermore, in the following detailed description of the present disclosure, specific numerical values are only examples, and the scope of the present disclosure is not limited thereby.

In the following descriptions of the components of the exemplary embodiments of the present disclosure, terms such as first, second, A, B, (a), (b), and so forth may be used. These terms are used merely to distinguish corresponding components from other components, and the natures, sequential positions, and/or orders of the corresponding components are not limited by the terms. Furthermore, unless defined otherwise, all the terms used herein, including technical or scientific terms, include the same meanings as commonly understood by those skilled in the art to which an exemplary embodiment of the present disclosure pertains. Terms such as those defined in commonly used dictionaries should be interpreted as having meanings consistent with the meanings in the context of related art, and should not be interpreted as having ideal or excessively formal meanings unless explicitly defined in the present application.

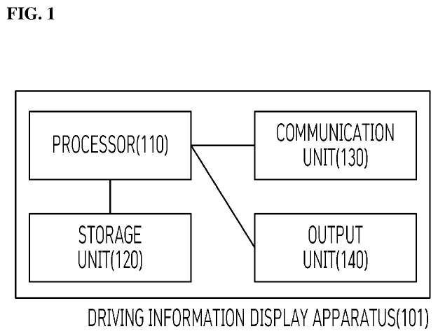

Embodiments of the present disclosure will be described in detail below with reference to FIGS. 1 to 10.

FIG. 1 is a block diagram showing the internal configuration of a driving information display apparatus 101 according to various exemplary embodiments of the present disclosure.

The driving information display apparatus 101 according to the exemplary embodiment of the present disclosure may be provided inside a means of transportation such as a vehicle, or may be implemented in a detachable form. The driving information display apparatus 101 may generally include the form of a vehicle navigation system, an audio, video and navigation (AVN) system, a head-up display (HUD), or the like, and may be implemented in a form in which an application is provided on a mobile phone terminal such as a smartphone.

The driving information display apparatus 101 according to the exemplary embodiment of the present disclosure may be present in a form of a server outside a means of transportation such as a vehicle. In the instant case, the driving information display apparatus 101 may be implemented to generate driving guidance information by processing determinations while being present outside a means of transportation and to output the driving guidance information to a display present inside the means of transportation. Furthermore, various embodiments may be implemented. The scope of rights of the present disclosure is not limited by the forms of such implementations.

Furthermore, the driving information display apparatus 101 of the exemplary embodiment of the present disclosure may operate in conjunction with devices for autonomous driving control such as an advanced driver assistance system (ADAS), a smart cruise control (SCC) system, a forward collision warning (FCW) system, and/or the like.

As shown in the drawing, the driving information display apparatus 101 according to the exemplary embodiment of the present disclosure may include a processor 110, a storage unit 120, a communication unit 130, and an output unit 140.

The processor 110 is configured to control the storage unit 120, the communication unit 130, and the output unit 140 to execute an application, process data according to the algorithm defined in the application, communicate with an external module, and provide the results of the processing to a user.

The processor 110 may refer to a chip for processing a general algorithm, such as a central processing unit (CPU) or an application processor (AP), or a set of such chips. The processor 110 may refer to a chip optimized for floating-point arithmetic, such as a general-purpose computing on graphics processing unit (GPGPU), to process an artificial intelligence algorithm such as deep learning, or a set of such chips. Alternatively, the processor 110 may refer to a module in which various types of chips perform an algorithm and process data in a connected and distributed manner.

The processor 110 may be electrically connected to the storage unit 120 and the communication unit 130, may electrically control the individual components, may be an electric circuit which executes software commands, and may perform various types of data processing and determination to be described later. The processor 110 may be, for example, an electronic control unit (ECU), a micro-controller unit (MCU), or another lower level controller which is mounted on a means of transportation.

The storage unit 120 stores road information and an algorithm executed by the processor. The road information may include map information, road traffic condition information, and/or the like. Depending on the configuration of the driving information display apparatus 101 of the present disclosure, the form or amount of road information stored inside the driving information display apparatus 101 may vary.

In some cases, the storage unit 120 may store road information including the map information and traffic condition information of all serviceable areas and provide services based on the road information. Alternatively, the storage unit 120 may temporarily store only road information related to a location where guidance is being made and provide services based on the temporarily stored road information.

This may be implemented as a different form depending on the form in which the driving information display apparatus 101 according to an exemplary embodiment of the present disclosure is implemented inside or outside a means of transportation, the communication method used, the storage space of the storage unit 120, and/or input/output speed. This is a part which may be chosen autonomously by those skilled in the art depending on the implementation situation. The scope of rights of the present disclosure is not limited by such changes in implementations.

The road information stored in the storage unit 120 may include not only general road information but also information related to the locations, capacities, and numbers of chargers of electric charging stations for the charging of electric vehicles. Based on these types of information, driving information guidance which considers the charging situation may be provided.

Furthermore, the road information stored in the storage unit 120 may include various types of display information to be displayed in guidance information. The display information may include various types of information to be included in the guidance information displayed in driving situations, such as intersections, traffic lights, crosswalks, destinations, and major landmarks. Furthermore, the display information included in the road information may include parking locations, entrance locations, ramps for movement between floors, indoor facilities, road information outside indoor sections connected to exits, and/or the like for guidance inside indoor sections. Such display information may each include a combination of the name of the display information to be displayed as guidance information and information related to the location where the corresponding display information will be displayed.

The storage unit 120 may have various forms, and may be at least one type of storage medium such as a flash memory-, hard disk-, micro-, card (e.g., secure digital (SD) card)-, extreme digital (XD) card-, random access memory (RAM)-, static RAM (SRAM)-, read-only memory (ROM)-, programmable ROM (PROM)-, electrically erasable PROM (EPROM)-, magnetic memory (MRAM)-, magnetic disk-, or optical disk-type storage medium, or the like. Depending on the amount, processing speed, storage time, and/or the like of data to be stored, a different type of storage medium or a combination of different types of storage media may be chosen.

The algorithm stored in the storage unit 120 may be implemented as a computer program in an executable form, and may be implemented to be stored in the storage unit 120 and then executed in a required situation. The algorithm stored in the storage unit 120 may be interpreted as including an instruction form which is temporarily loaded into volatile memory and instructs the processor to perform specific operations.

The communication unit 130 receives information for driving guidance from the outside of the driving information display apparatus 101 of the present disclosure over a wired/wireless communication network, and transmits necessary information to an external module.

The communication unit 130 may receive road information stored in the storage unit 120, an algorithm executed by the processor 110, and the like from an external module, and may transmit information related to the current state of a means of transportation to the outside to obtain necessary information related to the transmitted information. For example, the communication unit 130 may continuously receive traffic information from a traffic information server to check real-time traffic information, and is configured to transmit the location and route information of a means of transportation, found through a module such as a Global Positioning System (GPS) receiver, to the outside to obtain the real-time traffic information of an area related to the location and route of the means of transportation.

Furthermore, the communication unit 130 may be configured to transmit the internal and external information of a vehicle and receive information required for driving guidance while communicating with a driving information management server 201 which can process and provide information required for driving information guidance.

The communication unit 130 is a hardware device which is implemented using various electronic circuits to transmit and receive signals over a wireless or wired connection. In an exemplary embodiment of the present disclosure, the communication unit 130 may perform communication within a means of transportation using infra-transportation means network communication technology, and may perform Vehicle-to-Infrastructure (V2I) communication with a server, infrastructure, another means of transportation, and/or the like outside a means of transportation using wireless Internet access or short-range communication technology. In the instant case, the communication within a means of transportation may be performed using Controller Area Network (CAN) communication, Local Interconnect Network (LIN) communication, FlexRay communication, and/or the like as the infra-transportation means network communication technology. Furthermore, such wireless communication technology may include wireless LAN (WLAN), Wireless Broadband (WiBro), Wi-Fi, Worldwide Interoperability for Microwave Access (WiMAX), etc. Moreover, the short-range communication technology may include Bluetooth, ZigBee, Ultra-wideband (UWB), Radio Frequency Identification (RFID), Infrared Data Association (IrDA), etc.

The output unit 140 may output augmented reality information which is controlled by executing the algorithm, stored in the storage unit 120, by the processor 110. Augmented reality is a technology for enabling related information to be provided by adding graphic information to an image or scene of the real world.

The output unit 140 may be implemented as a head-up display (HUD), a cluster, an audio, video and navigation (AVN) system, a human-machine interface (HMI), and/or the like. Furthermore, the output unit 140 may include at least one of a liquid crystal display (LCD), a thin film transistor liquid crystal display (TFT LCD), a light emitting diode (LED) display, an organic light emitting diode (OLED) display, an active matrix OLED (AMOLED) display, a flexible display, a bended display, and a three-dimensional (3D) display. Some of these displays may be implemented as a transparent display configured in a transparent or translucent form to be able to view the outside thereof. Furthermore, the output unit 140 may be provided as a touch screen including a touch panel, and may be used as an input device as well as an output device.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, which drive on roads, but also various means of transportation, such as airplanes, drones, ships, etc.

Accordingly, in an exemplary embodiment of the present disclosure, the electric vehicle may be interpreted as being based on a concept including various means of transportation which store electrical energy in a secondary battery and use it as a power source among various means of transportation.

The driving information display apparatus 101 according to an exemplary embodiment of the present disclosure may have different exemplary embodiments depending on a method by which the processor 110 processes the information on which guidance is provided. Accordingly, the functions of the processor 110 will be described in detail below through specific embodiments.

As described above, the processor 110 is configured to perform control to receive driving guidance information and information related to the location of an electric vehicle and output a guidance screen corresponding to the driving guidance information. In the instant case, the driving guidance information may include a variety of types of information. When a driver sets a destination and wants to receive guidance information related to it through a screen, the driving guidance information may include information related to the destination and a route leading to the destination. Various types of other information for the driving guidance of a vehicle may be included in the driving guidance information.

In the case of an electric vehicle, the driving distance is short, charging takes a long time, and there are not a sufficient number of charging stations, so that it is important to provide accurate guidance on a charging station to pass through the charging station during route guidance. Accordingly, the processor 110 may be configured to provide guidance on an optimal route along which a driver may safely drive to a destination while charging an electric vehicle at a necessary point by use of electric vehicle charging station information included in the map information stored in the storage unit 120.

The processor 110 is configured to perform control to receive driving guidance information and information related to the location of a vehicle and output a guidance screen corresponding to the driving guidance information. When a driver sets a destination and wants to receive guidance information related to the destination through a screen, the driving guidance information may include information related to the destination and a route leading to the destination. Various types of other information for driving guidance of a vehicle may be included in the driving guidance information.

The driving guidance information received by the processor 110 may be the information received from a user, such as a destination, or may be the information generated using information stored in the storage unit 120, such as route information.

The location information of the vehicle received by the processor 110 may be the location information determined through a Global Positioning System (GPS) module or the like, as described above, and may be represented in a form which may be matched on map information stored in the storage unit 120.

When a charging station is included in the destination or passage point of the electric vehicle while route guidance is provided after a driver has input the destination, the processor 110 checks whether the driver has arrived at the charging station included in the destination or passage point.

When the electric vehicle arrives at the charging station, the processor 110 checks whether a charging station image output condition is satisfied, and is configured to perform control to output a charging station image of the arrived charging station through the output unit 140 when the charging station image output condition is satisfied.

Conventional driving information display apparatuses simply provide route guidance on the location of an electric vehicle charging station or briefly display information related to a charging station. However, the conventional driving information display apparatuses have limitations in accurately determining and providing information related to the state of a charging station and can provide only simple information, making it difficult to accurately provide up-to-date charging station state information. Accordingly, by providing recently captured images of charging stations to drivers who use the charging stations, the drivers can more accurately and clearly understand the states of the charging stations.

In another exemplary embodiment of the present disclosure, the processor 110 may be configured to perform control to, even before an electric vehicle arrives at a charging station, output a charging station image when a destination or passage point includes the charging station and allow a driver to determine whether to visit the charging station corresponding to the output charging station image.

Through this, the driver may accurately determine the state of the charging station included in the destination or passage point upon departure through the charging station image. When the state of the charging station is determined to be unsuitable for use, the driver may select another charging station as a destination or passage point.

The processor 110 may be configured to, when the destination or passage point of the electric vehicle includes a charging station, first provide a driver with a charging station image of the charging station, and search other charging stations excluding the corresponding charging station for an optimal charging station and then provide the optimal charging station to the driver when the driver expresses his or her intention not to use the charging station. Through this, the driver may accurately determine the state of the charging station through the charging station image and select and use a desired charging station.

The processor 110 outputs the charging station image only when the charging station image output condition is satisfied. The reason for this is to ensure that the charging station image is output only when necessary because, when the charging station image is displayed on the output unit 140, other screens such as route guidance may be obscured by the charging station image.

The charging station image output condition may be that the number of times the driver of the electric vehicle has visited the charging station in the past is less than a predetermined reference number. In the case of a charging station which the driver frequently uses, the driver may already know the location and state of the charging station even when the charging station image is not provided, so that it may be more convenient not to output the charging station image.

The reference number of times is the number of visits which allows the driver to be accustomed to using the charging station and may be set to about five times. The reference number may be set differently for each driver and may be determined according to a value set by the driver for the vehicle.

Furthermore, the processor 110 does not only output a charging station image only for a charging station visited less than a fixed reference number of times but may also determine whether to output a charging station image by checking the number of times a driver has visited a charging station within a predetermined recent period. In the case where a charging station has not been used recently even when the charging station has been used frequently in the past, variables such as a change in the location of a charger or the failure of a charger may occur. When a charging station has not been used recently, it may be desirable to provide a driver with a charging station image.

In the present manner, the processor 110 may be configured to generate the charging station image output condition by combining information related to the number of past visits and a recent visit by a driver for each charging station. This combination method may also be configured to be set in a vehicle by a driver.

Furthermore, the charging station image output condition may be configured to be satisfied when the time spanning from the point in time when an electric vehicle arrives at a charging station to the point in time when a parking completion signal is received exceeds a predetermined reference time. When a driver arrives at the charging station, but time passes without the completion of parking and the starting of charging, there is a strong possibility that the driver is unable to find a charger configured for charging.

Accordingly, the processor 110 may output a charging station image when time elapses without the parking of the electric vehicle after the electric vehicle has arrived at the charging station so that the driver can view the image and find the charger.

Furthermore, the charging station image output condition may be set to vary depending on state information such as time and weather or a driver's situation. For example, when it is difficult to find the location of a charger at night or when it is raining, a charging station image may be output even when other conditions are not satisfied. Furthermore, when a charging station is a destination, a charging station image may be output regardless of other conditions. In contrast, when a charging station is a passage point, a charging station image may be output only when other conditions are satisfied.

The processor 110 may also provide charging station information regarding a corresponding charging station while outputting a charging station image. The charging station information may include all types of information which may be used as references for the use of the charging station, such as charger locations, charger manager contact information, charger capacity (kW) information, information related to the number of chargers, operating hours, and time. The information may be the information stored in association with a charging station identifier in a previously established charging station information database.

The processor 110 may perform control to receive charging station information including a charging station image from the driving information management server 201 through the communication unit 130 and output the received charging station information through the output unit 140.

The charging station information output together with the charging station image is output together with the charging station image when the charging station image output condition is satisfied. When the charging station image output condition is not satisfied, the charging station information may be displayed as pop-up information not to obscure route guidance information.

Furthermore, the processor 110 may add information related to a charging station to a charging station image to be displayed and then output the charging station image by use of augmented reality technology. When augmented reality technology is used, a driver may check the information related to the charging station at a glance while viewing the charging station image, allowing the driver to use the charging station information conveniently.

Furthermore, the processor 110 may identify an area corresponding to a charging station image in images surrounding a vehicle received through the vehicle's camera by use of image processing technology using artificial intelligence, and may output charging station-related information into the identified area by use of augmented reality technology. Furthermore, various methods may be applied to the display of charging station information.

To be able to check the newest charging station state through a charging station image output through the output unit 140, the charging station image needs to be continuously updated. When a charging station image is received from a charging station manager or management company, continuous state information may not be checked, and the situation of the provided image may differ from an actual situation.

Accordingly, the processor 110 may perform control to capture an image with a camera attached to an electric vehicle when the electric vehicle arrives at a charging station and the charging port of the electric vehicle is opened and transmit the captured image, together with information for identifying the arrived charging station, to the driving information management server 201.

The charging port opens when the electric vehicle arrives in front of a charger at the charging station and begins charging. Accordingly, in the present situation, when the vehicle captures a charging station image and transmits the charging station image to a server so that it may be managed, the newest charging station image may be provided to other vehicles used in the future.

To capture the accurate state of a charger, the processor 110 may perform control to select one camera from a plurality of cameras attached to an electric vehicle based on information related to the direction in which the charging port of the electric vehicle is located and capture an image of the charger.

When the charging port of an electric vehicle is located in the front of the vehicle, the front of the vehicle faces the charger, so that a charging station image may be captured through a camera which captures an area in front of the vehicle. In contrast, when the charging port of an electric vehicle is located at the rear of the vehicle, the rear of the vehicle faces the charger, so that a charging station image may be captured through a camera which captures an area behind the vehicle.

In some cases, a charger may be located on a side of a vehicle, in which case a camera located on the side of the vehicle may be used. Even in the instant case, a side camera located in the direction of the charging port of the vehicle may be used.

To the present end, the processor 110 may refer to information in a database which stores information related to the location at which a charger is located relative to the vehicle in a charging station at which the electric vehicle arrives.

The camera which captures a charging station image may be a built-in camera which captures an image of the front or rear of an electric vehicle, the camera of an advanced driver assistance system (ADAS) when the vehicle is provided with the ADAS, or a surround view monitor (SVM) camera when the vehicle is provided with an SVM function. Furthermore, any camera may be utilized as long as it may be controlled by the processor 110 and capture an image of the surroundings of the vehicle.

The camera which the processor 110 can control is different depending on the type of electric vehicle, so that the storage unit 120 stores information related to a camera which the processor 110 can control together with information related to the direction in which the camera can capture images. The processor 110 may capture an image including a charger by use of the information stored in the storage unit 120.

When the location of a charger is in a blind spot which cannot be captured by the camera of an electric vehicle being charged, the processor 110 identifies an image including the charger among the past images captured while the vehicle entered a parking space for charging and then transmit the image to the driving information management server 201.

To the present end, the processor 110 may use artificial intelligence image analysis technology which can identify a charger image in an image. It is not limited by a specific method. However, the artificial intelligence image analysis technology may be configured to extract a shape similar to the shape of a charger, included in past conventional charging station image information received from the driving information management server 201, from an image and transmit it to the driving information management server 201 to be used as a new charging station image.

The processor 110 transmits charging station information including at least one of the success/failure of charging, charging speed, and charging time, together with the captured image, to the driving information management server 201. By transmitting various types of information related to charging together with an image of a charger which actually performed charging, drivers who later use the charger can determine the accurate state information for each charger.

For example, when a driver arrives at a charger and attempt to charge an electric vehicle but fails, he or she may guide future users to avoid that charger and use another charger by transmitting information related to the failure of charging together with a charging station image for that charger.

Furthermore, when charging is successful, detailed information related to actual charging, such as the charging speed of the charger, may be transmitted so that drivers who use the charger later can use the information to select a charging station and a charger.

The processor 110 transmits information for identifying the arrived charging station to the driving information management server 201, receives a charging station image of the arrived charging station from the driving information management server 201, and outputs the charging station image of the arrived charging station. The charging station image may be an image which is selected from images, captured and transmitted by a plurality of electric vehicles, by the driving information management server 201.

In other words, the driving information management server 201 collects the information previously received from the electric vehicles which used a corresponding charging station, and provides the newest information including accurate information to drivers who will use the charging station later, enabling the drivers to utilize the most up-to-date information.

When the driving information management server 201 selects a charging station image to be used among charging station images received from a plurality of electric vehicles, information such as the resolution of the image, the shooting time of the image, whether charging was successful, and whether a charger was accurately captured in the image may be criteria for the selection.

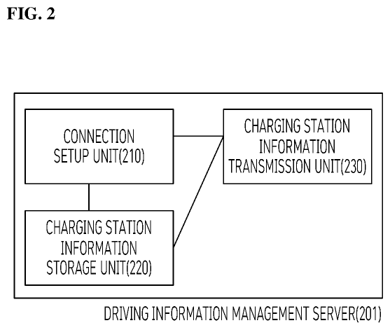

FIG. 2 is a block diagram showing the internal configuration of a driving information management server 201 according to various exemplary embodiments of the present disclosure.

The driving information management server 201 according to various exemplary embodiments of the present disclosure is a server provided with a central processing unit (CPU) including a processor and memory, and may include a standalone server or a cloud. The configuration of the driving information management server 201 is not limited as long as the driving information management server 201 can obtain a target remaining battery charge level by processing the information received from the above-described driving information display apparatus 101 over a wired or wireless communication network and transmit the target remaining battery charge level back to the driving information display apparatus 101 over a communication network.

The driving information management server 201 of the present disclosure stores the information and processes the operation required to generate the charging station information, such as a charging station image, displayed on the driving information display apparatus 101. Accordingly, the description provided in conjunction with the driving information display apparatus 101 may be applied to the driving information management server 201 without significant change.

As shown in the drawing, the driving information management server 201 may include a connection setup unit 210, a charging station information storage unit 220, and a charging station information transmission unit 230. Each of the components may be fabricated in a form of a software module which runs within the server.

The connection setup unit 210 sets up connections to exchange information with the driving information display apparatuses 101 of a plurality of electric vehicles. The connection setup unit 210 sets up connections with the communication units 130 of the driving information display apparatuses 101 over a wired or wireless communication network, and is not limited to a specific type of communication.

The charging station information storage unit 220 stores information for identifying charging stations and charging station images received from the driving information display apparatuses 101 of the plurality of electric vehicles over the set-up connections. As previously described in conjunction with FIG. 1, the processor 110 of the driving information display apparatus 101 captures an image including a charger when a driver utilizes a charging station. The charging station information storage unit 220 receives and stores charging station images from a plurality of electric vehicles, allowing the charging station images to be used in the driving information display apparatus 101 of an electric vehicle which will use a corresponding charging station later. To identify and provide a charging station image of a charging station actually used, information for identifying the charging station is stored in association with the charging station image.

The charging station information storage unit 220 receives charging station information including at least one of the success/failure of charging, charging speed, and charging time together with a captured charging station image, and stores them in association with the information for the identification of a charging station. As described above, to share the newest state information related to a charging station, information related to the success/failure of charging, charging speed, and charging time is received from an electric vehicle actually charged and is then stored. Using the present information, drivers who will later use the charging station may obtain accurate information related to the state of each charger of the charging station and select a charging station and a charger.

The charging station information storage unit 220 analyzes the received charging station image and stores the charging station image only when the image includes a charging station and the image quality of the image is equal to or greater than a reference value. To check whether the image includes a charging station, it may be possible to check whether an area having the characteristics of a charger is present by comparing the image with a conventional charging station image stored in the charging station information storage unit 220. Furthermore, to compare the image quality of the image, the resolution of the image may be identified. Various other technologies may be applied to analyze the image quality of an image.

By allowing the charging station information storage unit 220 to store only charging station images having usable quality as described above, when a charging station image is selected and transmitted, a more usable image may be rapidly selected.

The charging station information transmission unit 230 selects one image from the stored charging station images based on information for the identification of a charging station received from the driving information display apparatus of any one of the plurality of electric vehicles, and transmits the selected charging station image to the driving information display apparatus 101 which transmitted the information for the identification of a charging station.

The charging station information storage unit 220 stores the charging station images, transmitted from electric vehicles which used a charging station, for each charging station. Accordingly, when the driving information display apparatus 101 of an electric vehicle transmits information for the identification of a charging station to output a charging station image, the charging station information transmission unit 230 searches for charging station images corresponding to the information for the identification of a charging station, selects an optimal image from the found images, and transmits the optimal image to the driving information display apparatus 101.

In the instant case, the charging station information transmission unit 230 selects the charging station image, most recently captured when charging was successful, based on the stored charging station information. Through this, an image most recently captured by an electric vehicle which was actually successfully charged may be transmitted, allowing the charging station image to be continuously updated with the newest image.

Furthermore, the charging station information transmission unit 230 may use the results of analysis of the resolution and quality of charging station images to select a charging station image, and may use the result of analysis of whether parts representing the characteristics of a charger in each image were accurately captured.

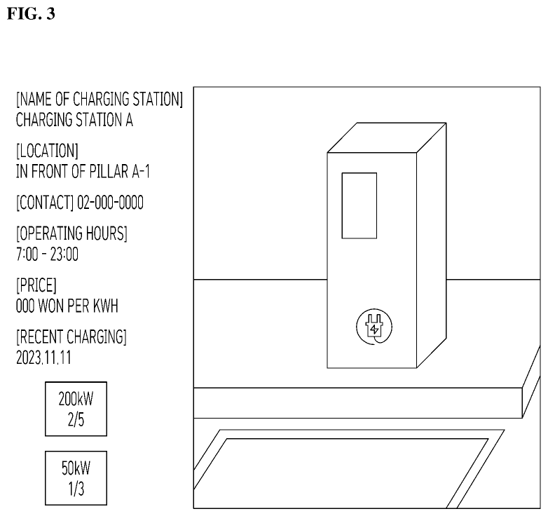

FIG. 3 is a diagram showing an example of charging station information output from a driving information display apparatus according to various exemplary embodiments of the present disclosure.

As shown in the drawing, the information related to a charging station output from the driving information display apparatus 101 through the output unit 140 may include a charging station image displayed on the right side of the drawing and charging station state information displayed on the left side.

The information displayed together with the charging station image may include various types of information such as a charging station name, a charging station location, manager contact information, operating hours, price, and the most recent successful charging date. Furthermore, the number of chargers for each charging speed, the number of chargers in use, and the number of chargers not in use may be identified individually.

Information related to the number of chargers in use may be information collected from each charging station. Information related to the number of chargers in use may be obtained from an electric vehicle currently using a corresponding charging station.

As shown in the drawing, when a driver arrives at a charging station, the or her may check a charging station image, and may rapidly find a charger within the space. Furthermore, when a charging station is included in a destination or passage point on a route and an image of the charging station is displayed in advance before the starting of driving, the state of the charging station is checked through the image and also the related information displayed on the left checking is checked, and then whether to use the charging station is selected. When the charging station is selected not to be used, another charging station may be recommended.

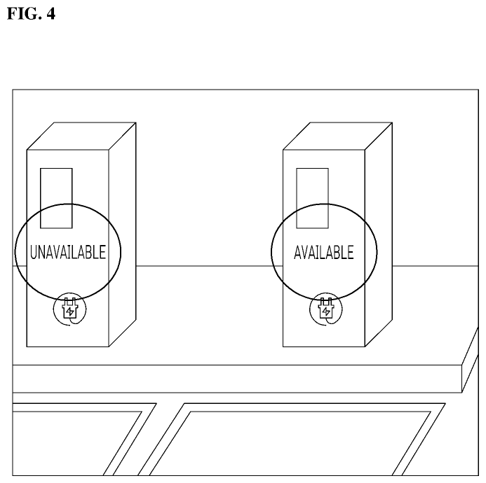

FIG. 4 is a diagram showing an example of displaying charging station information using augmented reality in a driving information display apparatus according to various exemplary embodiments of the present disclosure.

In an exemplary embodiment of the present disclosure, augmented reality technology may be applied in two ways to provide charging station information. The first way is to identify information, such as the location of a charger, in a charging station image to be displayed and output information related to a charging station at a required location.

When a plurality of chargers are captured in a charging station image, the charger on the right is a charger which was recently used for charging successfully by another driver and is thus determined to be usable, and the charger on the left is a charger which another driver recently failed to use for charging, as shown in the drawing, the location of each of the chargers may be identified within the image, and information indicating whether the charger is available may be overlaid and provided at the identified location.

In addition to the information indicating whether the charger is available, related information such as charging speed, charging time, and price are provided in addition to the location of each charger by use of augmented reality technology, allowing a driver to intuitively understand the information.

The second way is to determine an area corresponding to a charger included in a charging station image in an image captured by a camera of an electric vehicle and provide information related to the charger with the information overlaid on the image being captured in real time. Although the second way may require a lot of computation because the locations of chargers need to be accurately identified in the image in real time, a driver may more intuitively determine one of the chargers in front of him or her which he or she will use.

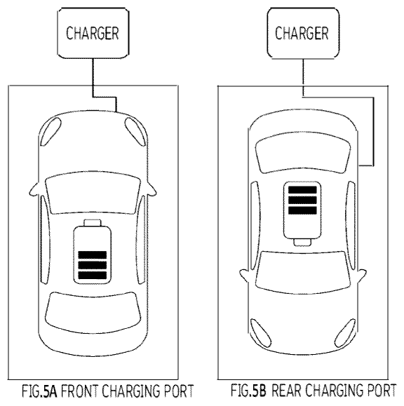

FIG. 5A and FIG. 5B are diagrams showing a method of capturing a charging station image according to the location of a charging port in a driving information display apparatus according to various exemplary embodiments of the present disclosure.

As shown in the drawing, the location of a charging port may be different for each type of electric vehicle. In some cases, the charging port is located in front of an electric vehicle, as shown in FIG. 5A, and in other cases, the charging port is located on a side of the rear portion of an electric vehicle, as shown in FIG. 5B. Other cases may also be present.

The location of a camera which can accurately capture an image of a charging station including a charger when an electric vehicle is charged differs according to the location of the charging port of the electric vehicle.

For example, in the case of FIG. 5A, the vehicle needs to be parked to face a charger and then charged with electricity, so that an image of a charging station including the charger may be captured only by use of the front camera of the vehicle.

In contrast, when the charging port is located on the rear portion of the vehicle, as in the case of FIG. 5B, a charger needs to be located behind the vehicle, so that an image of a charging station including the charger may be captured when the rear camera of the vehicle is used.

To the present end, the driving information display apparatus 101 of each electric vehicle is configured to perform control to store information related to the direction in which each available camera can capture images, select an optimal camera which can accurately capture an image of a charger, and then capture an image.

When there is a plurality of cameras which can capture images in the same direction, an image which includes the highest resolution or the best quality or which includes a charger may be selected from images captured in that direction and then used.

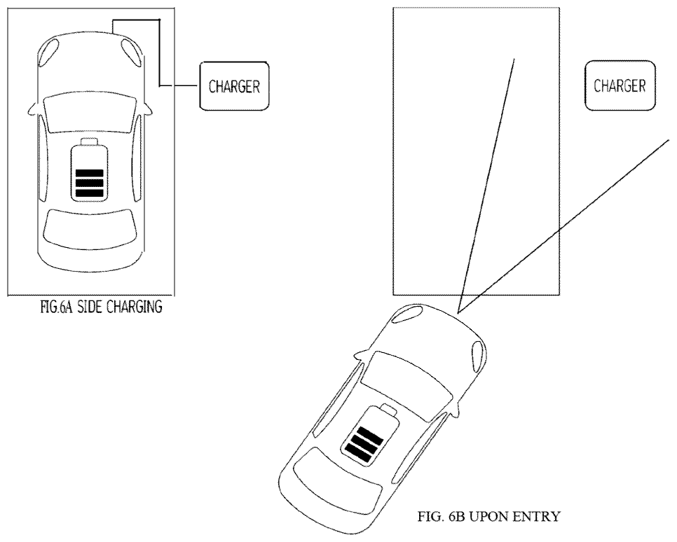

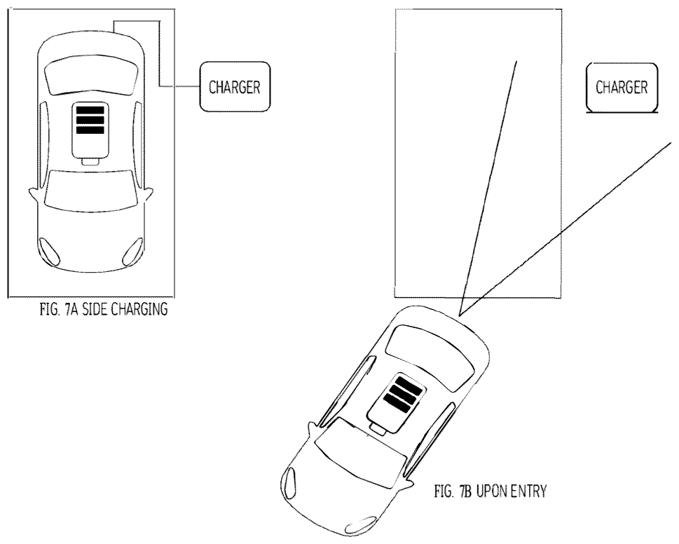

FIGS. 6A, 6B, 7A and 7B are diagrams showing a method of capturing an image of a charging station when it is difficult to capture an image during the charging of an electric vehicle in a driving information display apparatus according to various exemplary embodiments of the present disclosure.

As shown in the drawing, when a charger is located on a side of an area where an electric vehicle is parked for charging, it may be difficult to capture an image with the front or rear camera of the electric vehicle during charging. When a vehicle is provided with an AVM, there may be a camera which can capture an image of the side. However, in other cases, it is difficult to capture an image of the side, making it difficult to generate a charging station image.

FIG. 6A and FIG. 6B show cases where the charging port of a vehicle is located in front of the vehicle, and FIG. 7A and FIG. 7B show cases where the charging port of a vehicle is located on the rear of the vehicle.

When a charger is located at a location spaced apart outwardly from a side of the front portion of a parking space as shown in FIG. 6A and FIG. 6B, an electric vehicle needs to be parked and charged with electricity with the front thereof facing the front of the parking space. As shown in FIG. 6A, in the instant case, even when an image is captured with the front camera of the vehicle, the charger is not included in the image.

Accordingly, in the instant case, an image including the charger may be selected from images captured in a process of entering the parking space before being parked in the parking space, as shown in FIG. 6B, and then used as a charging station image.

For the present purpose, when a vehicle enters a charging station area, images captured by the camera may be stored at predetermined intervals, and an image including the charger may be selected from recently captured images when the vehicle is parked and then the charging port of the electric vehicle is opened.

To select an image including a charger, an operation may be performed to determine whether an area having the features of the charger is present by comparing it with a charging station image captured by another electric vehicle.

FIG. 7A and FIG. 7B show cases where a charger is located at the same location as in FIG. 6A and FIG. 6B but the charging port of an electric vehicle is located on the rear thereof. In the instant case, the electric vehicle drives rearward and then parked. After parking is completed as shown in FIG. 7A, the charger is not included in an image even when the image is captured with a rear camera. Accordingly, an image including the charger is selected from images captured during a rearward entry process, as shown in FIG. 7B.

In the case where a charging port is located on the right side of the rear portion of an electric vehicle, unlike in the case of FIG. 7A and FIG. 7B, even when the charging port is located on the rear portion of the vehicle, a situation will occur where the vehicle drives forward. In the instant case, it may be desirable to use an image captured by a front camera during the process of entering a parking space, as in the case of FIG. 6A and FIG. 6B.

As described above, an optimal camera and capturing time for capturing a charger may differ according to the location of the charger and the location of the charging port of an electric vehicle. Accordingly, the driving information display apparatus 101 checks information related to the location of the charging port of a vehicle and the location of a charger of a corresponding charging station, and is configured to determine a camera and viewpoint for capturing a charger image based on the information.

Information related to the location of each charger for each charging station may be organized into a database in advance in the driving information management server 201, and may be received from the driving information management server 201 and then utilized upon entry into the charging station.

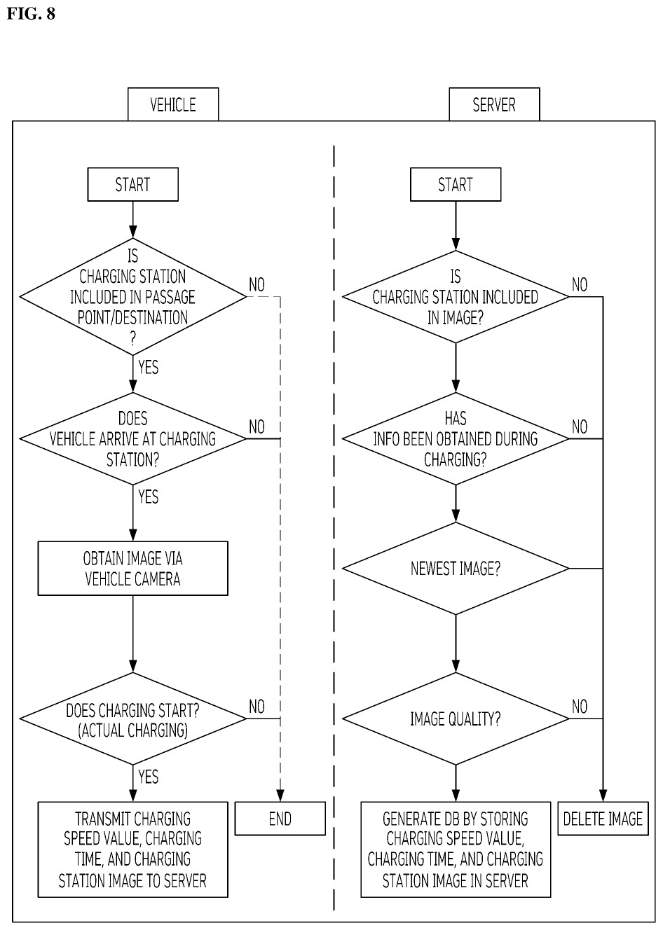

FIG. 8 shows flowcharts of the operations of the driving information display apparatus and the driving information management server according to various exemplary embodiments of the present disclosure.

The drawing schematically shows the operations of the driving information display apparatus 101 and the driving information management server 201 described above. The portion entitled “Vehicle” on the left side of the drawing shows the operation of the driving information display apparatus 101 mounted on an electric vehicle. The portion entitled “Server” on the right side of the drawing shows the operation of the driving information management server 201.

As described above, the driving information display apparatus 101 checks whether a charging station is included in a destination or passage point on the route of an electric vehicle, and is configured to determine whether the vehicle has arrived at the charging station when the charging station is included in the destination or passage point.

When it is determined that the electric vehicle has arrived at the charging station, an image is obtained through a camera of the vehicle. As described above, a camera which can accurately capture a charger is identified among the cameras of the vehicle, and an image of the charging station is captured so that the charger may be included in the image of the charging station.

When actual charging is performed, success/failure, charging time, and a charging station image are transmitted to the driving information management server 201 after the completion of charging. In contrast, when charging is not performed, the process is terminated. In the instant case, even when charging is not performed, a charging station image together with information indicating that charging has failed may be transmitted so that subsequent drivers can check this.

The driving information management server 201 checks whether the charger is accurately captured in the charging station image received from the driving information display apparatus 101, checks whether the information related to charging has been accurately received, checks whether the image is the newest image, and finally checks whether the image quality of the image is equal to or greater than a reference value. Thereafter, the driving information management server 201 stores the charging station image and the charging information in a database.

In the instant case, the process of filtering the image may be performed before the storage, as shown in the drawing. It may also be possible to perform the present filtering process when selecting a charging station image to be transmitted after storing all images received from the driving information display apparatus 101. All such modifications fall within the scope of the present disclosure.

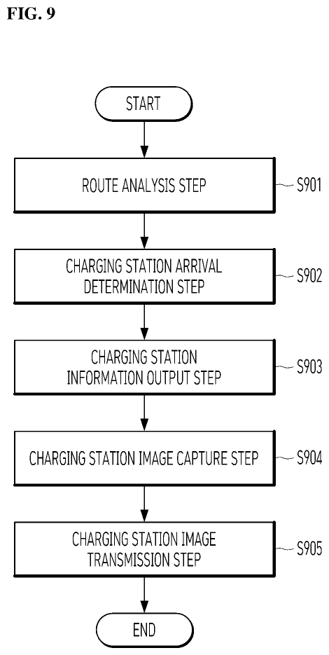

FIG. 9 is a flowchart showing the flow of a driving information display method according to various exemplary embodiments of the present disclosure.

In the exemplary embodiment of the present disclosure, the driving information display method according to an exemplary embodiment of the present disclosure is a method which is performed by the driving information display apparatus 101 provided with the processor 110 and the storage unit 120. The components described above in conjunction with the operation of the driving information display apparatus 101 may be applied to the driving information display method without significant change. Accordingly, those skilled in the art may implement even the components for which there are no specific descriptions in conjunction with the driving information display method below by applying the foregoing description of the driving information display apparatus 101.

In a route analysis step S901, it is determined whether a charging station is included in the destination or passage point of an electric vehicle to which the driving information display apparatus is attached.

In a charging station arrival determination step S902, it is determined whether an electric vehicle has arrived at the charging station included in the destination or passage point.

In a charging station information output step S903, it is checked whether the charging station image output condition is satisfied, and a charging station image of the arrived charging station is output when the charging station image output condition is satisfied.

In the instant case, the charging station image output condition may be satisfied when the number of times the driver of the electric vehicle has visited the charging station in the past is less than a predetermined reference number, or may be satisfied when the time spanning from the point in time when the electric vehicle arrives at the charging station to the point in time when a parking completion signal is received exceeds a predetermined reference time.

In a charging station image capture step S904, when the electric vehicle arrives at the charging station and the charging port of the electric vehicle is opened, an image is captured with a camera attached to the electric vehicle.

In the charging station image capture step S904, one camera is selected from a plurality of cameras attached to the electric vehicle based on information related to the direction in which the charging port of the electric vehicle is placed, and the image is captured with the selected camera.

In a charging station image transmission step S905, the captured image, together with information for identifying the arrived charging station, is transmitted to the driving information management server.

In the charging station image transmission step S905, the charging station information including at least one of the success/failure of charging, charging speed, and charging time, together with the captured image, is transmitted to the driving information management server.

Furthermore, in the charging station image transmission step S905, the information for identifying the arrived charging station is transmitted to the driving information management server. In the charging station image output step, a charging station image of the arrived charging station is received from the driving information management server and then output, in which case the charging station image may be an image selected from the images, captured and transmitted by a plurality of electric vehicles, by the driving information management server.

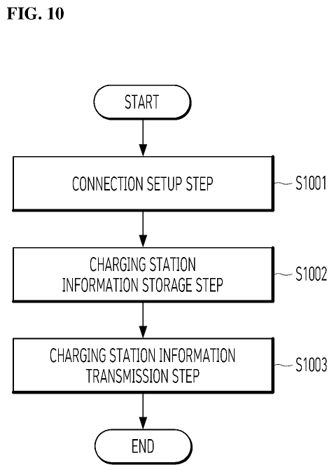

FIG. 10 is a flowchart showing the flow of a driving information management method according to various exemplary embodiments of the present disclosure.

In the exemplary embodiment of the present disclosure, the driving information management method according to an exemplary embodiment of the present disclosure is a method which is performed by the driving information management server 201 including the CPU and the memory. The components described above in conjunction with the operation of the driving information management server 201 may be applied to the driving information management method without significant change. Accordingly, those skilled in the art may implement even the components for which there are no specific descriptions in conjunction with the driving information management method below by applying the foregoing description of the driving information management server 201.

In a connection setup step S1001, connections are to set up to exchange information with the driving information display apparatuses of a plurality of electric vehicles.

In a charging station information storage step S1002, the information for the identification of a charging station and charging station images received from the driving information display apparatuses of the plurality of electric vehicles over the set-up connections are stored.

In the instant case, in the charging station information storage step S1002, charging station information including at least one of the success/failure of charging, charging speed, and charging time, together with a captured image, is received, and is then stored in association with the information for the identification of a charging station.

In a charging station information transmission step S1003, one charging station image is selected from the stored charging station images based on the information for the identification of a charging station received from the driving information display apparatus of any one of the plurality of electric vehicles, and is transmitted to the driving information display apparatus which transmitted the information for identifying the charging station.

In a charging station information transmission step S1003, a charging station image most recently captured when charging was successful is selected based on the stored charging station information and is then transmitted.

Furthermore, in the charging station information storage step S1003, the received charging station image is analyzed, and then the charging station image is stored only when the image includes a charging station and the image quality of the image is equal to or greater than a reference value.

The present disclosure may achieve the advantage of providing accurate and detailed information related to an electric vehicle charging station.

The present disclosure may achieve the advantage of providing a recent image of an electric vehicle charging station so that a driver can accurately check the state of the charging station.

The present disclosure may achieve the advantage of extracting a charging station image from an image obtained through a camera of an electric vehicle and providing a charging station image corresponding to the success of charging to a driver so that the driver can check the accurate state of a charging station.

The present disclosure may achieve the advantage of extracting and providing the newest charging station image by analyzing images received from vehicles which used a vehicle charging station without separately capturing the electric vehicle charging station.

Furthermore, various advantages which may be directly or indirectly understood by those skilled in the art may be provided throughout the present specification.

Although the present disclosure has been described with reference to the embodiments, those skilled in the art may variously modify and change the present disclosure without departing from the spirit and scope of the present disclosure described in the attached claims.

The control device may be at least one microprocessor operated by a predetermined program which may include a series of commands for carrying out the method included in the aforementioned various exemplary embodiments of the present disclosure.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit,” “module,” etc. included in the specification mean units for processing at least one function or operation, which may be implemented by hardware, software, or a combination thereof.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper,” “lower,” “inner,” “outer,” “up,” “down,” “upwards,” “downwards,” “front,” “rear,” “back,” “inside,” “outside,” “inwardly,” “outwardly,” “internal,” “external,” “internal,” “external,” “forwards,” and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A,” “B,” and “A and B.”

In the present specification, unless stated otherwise, a singular expression includes a plural expression unless the context clearly indicates otherwise.

In exemplary embodiments of the present disclosure, “at least one of A and B” may refer to “at least one of A or B” or “at least one of combinations of at least one of A and B.” Furthermore, “one or more of A and B” may refer to “one or more of A or B” or “one or more of combinations of one or more of A and B.”

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A driving information display apparatus comprising:
a processor configured to perform control to receive driving guidance information and location information of an electric vehicle and output a guidance screen corresponding to the driving guidance information; and
a storage unit configured to store road information and an algorithm run by the processor;
wherein the processor is configured to perform control to, in response that a charging station is included in a destination or passage point of the electric vehicle:
check whether the electric vehicle has arrived at the charging station included in the destination or passage point; and
determine whether a charging station image output condition is satisfied, and output a charging station image of the arrived charging station in response that the charging station image output condition is satisfied.

2. The driving information display apparatus of claim 1, wherein the charging station image output condition is satisfied when a number of times a driver of the electric vehicle has visited the charging station in a past is less than a predetermined reference number.

3. The driving information display apparatus of claim 1, wherein the charging station image output condition is satisfied when a time spanning from a point in time that the electric vehicle arrives at the charging station to a point in time that a parking completion signal is received exceeds a predetermined reference time.

4. The driving information display apparatus of claim 1, wherein the processor is further configured to perform control to:
capture an image with a camera attached to the electric vehicle in response that the electric vehicle arrives at the charging station and a charging port of the electric vehicle is opened; and
transmit the captured image, together with information for identifying the arrived charging station, to a driving information management server.

5. The driving information display apparatus of claim 4, wherein the processor is further configured to perform control to:
select one camera from a plurality of cameras attached to the electric vehicle based on information related to a direction in which the charging port of the electric vehicle is placed; and
capture the image.

6. The driving information display apparatus of claim 4, wherein the processor is further configured to perform control to transmit charging station information including at least one of success or failure of charging, charging speed, and charging time, together with the captured image, to the driving information management server.

7. The driving information display apparatus of claim 4, wherein the processor is further configured to perform control to:
transmit information for identifying the arrived charging station to the driving information management server; and
receive a charging station image of the arrived charging station from the driving information management server, and output the charging station image;
wherein the charging station image is an image which is selected from images, captured and transmitted by a plurality of electric vehicles, by the driving information management server.

8. A driving information management server provided with a central processing unit and memory, the driving information management server comprising:
a connection setup unit configured to set up connections to exchange information with driving information display apparatuses of a plurality of electric vehicles;
a charging station information storage unit configured to store information for identifying charging stations and charging station images received from the driving information display apparatuses of the plurality of electric vehicles over the set-up connections; and
a charging station information transmission unit configured to select an image from the stored charging station images based on information for identification of a charging station received from the driving information display apparatus of any one of the plurality of electric vehicles, and transmit the selected charging station image to the driving information display apparatus which transmitted the information for identification of the charging station.

9. The driving information management server of claim 8, wherein the charging station information storage unit receives charging station information including at least one of success or failure of charging, charging speed, and charging time together with each of the charging station images captured by the plurality of electric vehicles, and stores the charging station information in association with the information for identification of the charging station.

10. The driving information management server of claim 9, wherein the charging station information transmission unit selects and transmits a charging station image, most recently captured in response that charging was successful, based on the stored charging station information.

11. The driving information management server of claim 10, wherein the charging station information storage unit analyzes the received charging station image and stores the charging station image only when the image includes the charging station and an image quality of the image is equal to or greater than a reference value.

12. A driving information display method, the driving information display method being performed by a driving information display apparatus provided with a processor and a storage unit, the driving information display method comprising:
determining, by the processor, whether a charging station is included in a destination or passage point of an electric vehicle to which the driving information display apparatus is attached;
determining, by the processor, whether the electric vehicle has arrived at the charging station included in the destination or passage point.
checking, by the processor, whether a charging station image output condition is satisfied, and outputting a charging station image of the arrived charging station in response that the charging station image output condition is satisfied.

13. The driving information display method of claim 12, wherein the charging station image output condition is satisfied when a number of times a driver of the electric vehicle has visited the charging station in a past is less than a predetermined reference number.

14. The driving information display method of claim 12, wherein the charging station image output condition is satisfied when a time spanning from a point in time that the electric vehicle arrives at the charging station to a point in time that a parking completion signal is received exceeds a predetermined reference time.

15. The driving information display method of claim 12, further including:
capturing, by the processor, an image with a camera attached to the electric vehicle in response that the electric vehicle arrives at the charging station and a charging port of the electric vehicle is opened; and
transmitting, by the processor, the captured image, together with information for identifying the arrived charging station, to a driving information management server.

16. A non-transitory computer-readable storage medium having stored thereon a program that, when executed by the processor, causes the processor to execute the driving information management method of claim 12.

17. A driving information management method, the driving information management method being performed by a driving information management server provided with a central processing unit and a memory, the driving information management method comprising:
a connection setup step of setting up, by the central processing unit, connections to exchange information with driving information display apparatuses of a plurality of electric vehicles;
a charging station information storage step of storing, by the central processing unit, information for identifying charging stations and charging station images received from the driving information display apparatuses of the plurality of electric vehicles over the set-up connections; and
a charging station information transmission step of selecting, by the central processing unit, an image from the stored charging station images based on information for identification of a charging station received from the driving information display apparatus of any one of the plurality of electric vehicles, and transmit the selected charging station image to the driving information display apparatus which transmitted the information for identification of the charging station.

18. The driving information management method of claim 17, wherein the charging station information storage step includes receiving charging station information including at least one of success or failure of charging, charging speed, and charging time together with each of the charging station images captured by the plurality of electric vehicles and storing the charging station information in association with the information for identification of the charging station.

19. The driving information management method of claim 18, wherein the charging station information transmission step includes selecting and transmitting a charging station image, most recently captured in response that charging was successful, based on the stored charging station information.

20. The driving information management method of claim 19, wherein the charging station information storage step includes analyzing the received charging station image and storing the charging station image only when the image includes the charging station and an image quality of the image is equal to or greater than a reference value.
